(19) United States
(12) Patent Application Publication
(10) Pub. No.: US 2006/0139300 A1
(43) Pub. Date: Jun. 29, 2006

(54) Backlight device using a field emission light source

(75) Inventor: Ga-Lane Chen, Fremont, CA (US)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI Precision Industry CO., LTD., Tu-Cheng City (TW)

(21) Appl. No.: 11/287,008

(22) Filed: Nov. 23, 2005

(30) Foreign Application Priority Data
Dec. 29, 2004 (CN) 200410091920.5

(51) Int. Cl. G09G 3/36

(52) U.S. Cl. 345/102

(57) ABSTRACT

A backlight device (100) includes a light source (110) and a light guiding plate (120). The light source includes a cathode (111); a nucleation layer (112) formed on the cathode; a field emission portion (102) formed on the nucleation layer; and a light-permeable anode (117) arranged over the cathode. The field emission portion includes an isolating layer (113) formed on the cathode; a plurality of isolating posts (114) disposed on the isolating layer; and a plurality of field emitters (115) located on the respective isolating posts. The light guiding plate includes an incident surface (121) facing the light-permeable anode and adapted for receiving light emitted from the light source.

### FIELD OF THE INVENTION

The present invention relates to liquid crystal display (LCD) technology and, more particularly, to a light source for a liquid crystal display and a backlight device employing it.

### BACKGROUND

In general, an LCD apparatus has many advantages over a CRT (cathode ray tube) display apparatus, especially in respect to weight and size. The advantage of an LCD derives from its use of liquid crystal for providing images. The liquid crystal is controlled by an electric field. Under an applied electric field, liquid crystal molecules are oriented in a predetermined direction parallel to a direction of the electric field. Light transmittance for providing images varies according to the orientations of the liquid crystal molecules.

The LCD apparatus requires a light source to illuminate the liquid crystal. The quality of the displayed images depends on a uniformity of the light luminance and the brightness of the light.

Referring to FIG. 1 (Prior Art), a backlight device 10 includes a light guiding plate 22; two light emitting diodes 201, 202 arranged at a side of the light guiding plate 22; and a reflecting plate 23 arranged below the light guiding plate 22.

FIG. 2 (Prior Art) shows essential paths of light emitted from the light emitting diodes 201, 202 to the light guiding plate 22. Because each of the light emitting diodes 201, 202 is a point light source, the light emitted from each is generally limited within a conical region. Therefore, when the light emitted from the light emitting diodes 201, 202 enters into the light guiding plate 22, some portions of the light guide plate 22, such as portions 261, 262, 263 are not illuminated by the light, thereby forming a plurality of so-called dark zones.

Conventional linear light sources employed in the backlight devices of the liquid crystal displays generally include electroluminescent lamps and cold cathode fluorescence lamps. Nevertheless, all of the above-mentioned light sources have a common shortcoming that they cannot provide a satisfactory high light brightness and uniformity. In order to achieve a higher uniform brightness using such lamps, a higher voltage or more light sources would have to be required. Therefore, energy consumption is undesirably increased accordingly.

What is desired is a backlight device for liquid crystal displays that is able to achieve a high uniform brightness without undesirably requiring an increase in energy consumption.

### SUMMARY

A backlight device provided herein generally includes a light source and a light guiding plate. The light source includes a cathode; a base having at least one isolating supporter disposed on the cathode; at least one field emitter, each field emitter being formed on a respective isolating supporter of the base; and a light-permeable anode arranged over and facing the at least one field emitter. The light guiding plate includes an incident surface facing the light-permeable anode, the incident surface being adapted for receiving light emitted from the light source.

The isolating supporter may include an isolating layer.

The isolating supporter may alternatively include an isolating post. Preferably, the isolating post and the field emitter have a total length ranging from about 100 nanometers to about 2000 nanometers. In addition, the isolating post may have a diameter ranging from about 10 nanometers to about 100 nanometers. Furthermore, the isolating post may be, e.g., cylindrical, conical, annular, or parallelepiped-shaped.

The isolating supporter may, beneficially, be made of silicon nitride.

The field emitter may be made of niobium or another emissive material. The field emitter preferably has a diameter ranging from about 0.5 nanometers to 10 nanometers.

The base may further include an electrically conductive connecting portion configured for establishing an electrically conductive connection between the field emitter and the cathode. Further, the isolating supporter may include a through hole, with the electrically conductive connecting portion received therein.

The light source may further include a nucleation layer interposed between the cathode and the base. Further, the nucleation layer may advantageously be made of silicon and preferably has a thickness in the range from about 2 nanometers to about 10 nanometers.

These and other features, aspects, and advantages of the present backlight device will become more apparent from the following detailed description and claims, and the accompanying drawings.

### BRIEF DESCRIPTION OF THE DRAWINGS

Many aspects of the present backlight device can be better understood with reference to the following drawings. The components in the drawings are not necessarily to scale, the emphasis instead being placed upon clearly illustrating the principles of the present backlight device. Moreover, in the drawings, like reference numerals designate corresponding parts throughout the several views.

FIG. 1 is a schematic, perspective view of a conventional backlight device employing two light emitting diodes as light sources;

FIG. 2 is a schematic view of light paths of the two light emitting diodes shown in FIG. 1;

FIG. 3 is a schematic, perspective view of a backlight device, in accordance with a first embodiment;

FIG. 4 is a schematic, side view of a light source of the backlight device shown in the FIG. 3;

FIG. 5 is a schematic, enlarged view of a field emitter and its corresponding isolating post shown in the FIG. 4;

FIG. 6 is a schematic, perspective view of another light source for a backlight device, in accordance with a second embodiment; and

FIG. 7 is a schematic, enlarged view of a field emitter and its corresponding isolating post shown in the FIG. 6.

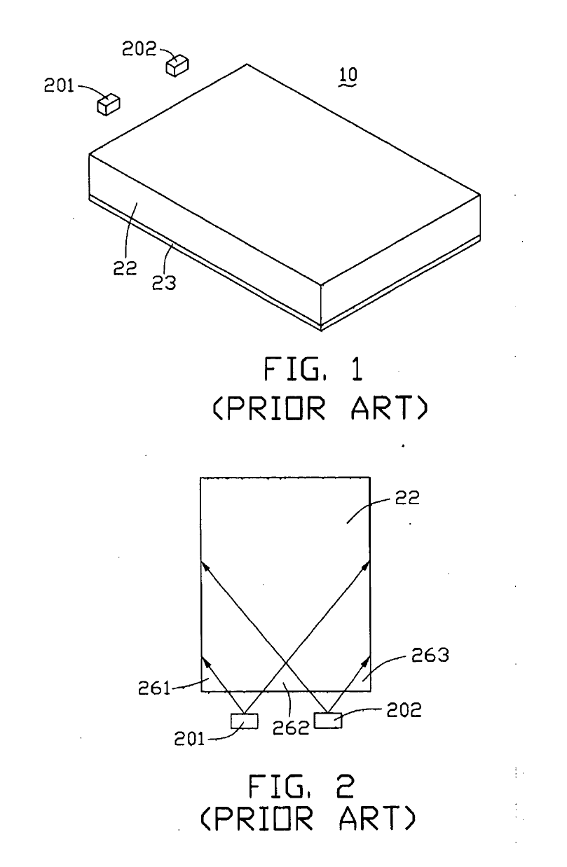

### DETAILED DESCRIPTION OF THE PREFERRED EMBODIMENTS

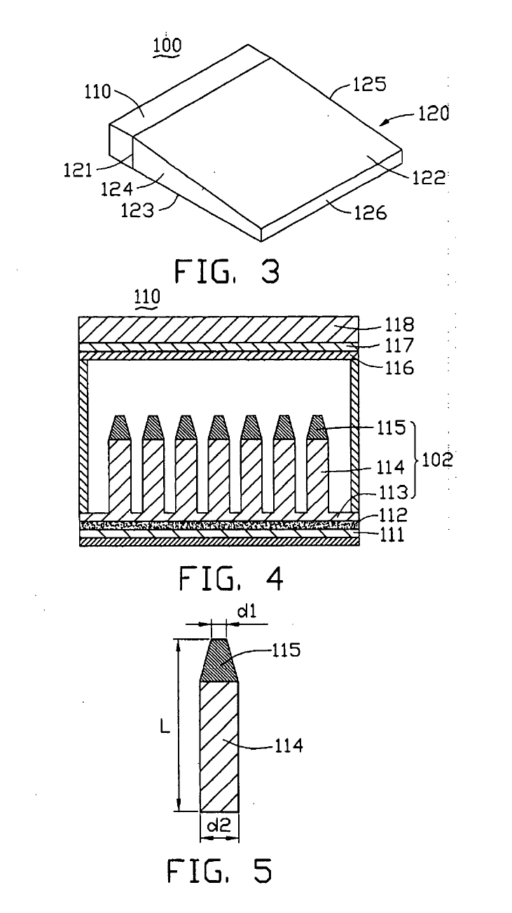

FIG. 3 shows a backlight device 100 in accordance with a first embodiment. The backlight device 100 includes a light source 110 and a light guiding plate 120. The light source 110 is arranged at a side face of the light guiding plate 120.

The light guiding plate 120 is generally in a form of a flat or wedge-shaped sheet that includes a light incident surface 121, a light emitting surface 122, a light reflecting surface 123, and reflecting side surfaces 124, 125, 126, formed, optionally, with reflecting layers thereon. The light incident surface 121 is disposed facing the light source 110 and is adapted/configured for receiving light emitting therefrom. The light reflecting surface 123 is configured for reflecting the light incoming through the light incident surface 121. The light emitting surface 122 is opposite to the light reflecting surface 123 and is adapted for facilitating emission of light from the light guiding plate 120, including the exit of the reflected light. In the illustrated embodiment, the light guiding plate 120 is wedge-shaped. Alternatively, the light guiding plate 120 could be a substantially rectangular flat sheet having a generally uniform thickness. The light guiding plate 120 is generally made of a transparent material, such, for example, as PMMA, another optical plastic, or an optical glass.

In the first embodiment, the light source 110 is a field emission device. The light source 110 generally includes a cathode 111; a nucleation layer 112 formed on the cathode 111; a field emission portion 102 formed on the nucleation layer 112; and a light-permeable anode 117 arranged over the cathode 111. Spacers (not shown) may be interposed between the cathode 111 and the anode 117. The cathode 111 and the anode 117 cooperatively form a chamber therebetween that is advantageously evacuated to form a suitable level of vacuum (i.e., a level conducive to the free movement of electrons therethrough).

The anode 117 is generally a transparent conductive layer disposed on a substrate 118, the substrate 118 being made, e.g., of a glass or plastic material. The anode 117 is advantageously made of indium-tin oxide. At least one fluorescent layer 116 is formed on the anode 117 and faces the field emission portion 102. The anode 117 and the substrate 118 are beneficially highly transparent or at least highly translucent to permit most of the light generated by the at least one fluorescent layer 116 to reach the light incident surface 121.

The cathode 111 is generally a conductive layer made of one or more conductive metal materials, for example, gold, silver, copper, or their alloys.

The field emission portion 102 beneficially includes an isolating layer 113 formed on the cathode 111; a plurality of isolating posts 114 extending from the isolating layer 113; and a plurality of field emitters 115 formed on respective top ends of the isolating posts 114.

The isolating posts 114 can be configured to be cylindrical, conical, annular, parallelepiped-shaped, or other suitable configurations. The isolating layer 113 and the isolating posts 114 are advantageously made of essentially the same material as that used for the isolating layer 113, such as silicon nitride, carbon nitride, diamond-like carbon, or the like. Further, the isolating layer 113 is advantageously integrally formed with the isolating posts 114.

The field emitters 115 are formed on the top ends of the isolating posts 114 and project toward the anode 117. The field emitters 115 are advantageously made of niobium. For example, the field emitters 115 may be niobium nanorods, niobium nanotubes, or niobium nanoparticles. However, it is to be understood that field emitters 115 could be made of other emissive materials (e.g., carbon, silicon, or molybdenum) and/or could be otherwise configured of other shapes conducive to field emission generation.

The nucleation layer 112 is formed on the cathode 111, and the field emission portion 102 is, in turn, formed thereon. During manufacture, the nucleation layer 112 is utilized as a substrate for the depositing of the isolating layer 113 and the isolating posts 114 thereon. Thus, a material of the nucleation layer 112 should be chosen according to the materials of the isolating layer 113 and the isolating posts 114. For example, if the isolating layer 113 and the isolating posts 114 are both made of silicon nitride, the nucleation layer 112 is preferably made of silicon. The nucleation layer 112 is preferably configured to be as thin as possible. A thickness of the nucleation layer 112 is in the range from about 1 nanometer to about 100 nanometers. Preferably, the thickness of the nucleation layer 112 is in the range from about 2 nanometers to about 10 nanometers. The nucleation layer 112 is beneficially suitably conductive to facilitate conductance of electrons from the cathode 111 to the isolating layer 113/field emission portion 102.

Referring to FIG. 5, in order to simplify the description of the first embodiment, a single exemplary isolating post 114 and a related field emitter 115 are described as follows. The isolating post 114 is advantageously configured to be cylindrical or in other suitable configurations and has a diameter (or width) d2 in the range from about 10 nanometers to about 100 nanometers. The field emitter 115 is advantageously configured to be in a form of a frustum or a cone. A base of the field emitter 115 opportunely has a diameter about equal to the diameter d2 of the isolating post 114. A top end of field emitter 115 has a diameter d1 in the range from about 0.5 nanometers to about 10 nanometers. A total length L of the isolating post 114 and the corresponding field emitter 115 is advantageously in the range from about 100 nanometers to about 2000 nanometers.

The field emission portion 102 may be manufactured by the steps of:
(1) providing a silicon substrate;
(2) forming a silicon nitride layer having a predetermined thickness thereof on the silicon substrate, the silicon nitride layer being formed by a chemical vapor deposition process, an ion-beam sputtering process, or otherwise;
(3) depositing a niobium layer on the silicon nitride layer; and
(4) etching the niobium layer and the silicon nitride layer by a chemical etching process or otherwise, thereby obtaining the field emitter 115 and the isolating post 114. The silicon nitride layer may be utilized as the isolating layer 113.

In operation, electrons emitted from the field emitters 115 are, under an electric field applied by the cathode 111 and the anode 117, accelerated, and then collide with a fluorescent material of the fluorescent layer 116. The collision of the electrons upon the fluorescent layer 116 causes such layer 116 to fluoresce and thus emit light therefrom. The light passes through the anode 117 and the substrate 118 and then enters into the light guiding plate 120 through the light incident surface 121.

The backlight device 100 employing the light source 110 is compact in size and light in weight and is capable of providing a high, uniform brightness. Energy consumption of the backlight device 100 is relatively reduced. Particularly, a light emitting angle of the light source 110 is wider than that of the conventional light emitting diode. The light emitted from the light source 110 can cover the entire light incident surface 121 and exits all around from the entire light emitting surface 122 of the light guiding plate 120. Thus, the aforementioned dark zones are effectively minimized or even completely eliminated.

FIG. 6 illustrates an alternative light source 310 for the backlight device 100, in accordance with a second embodiment. The light source 310 includes a cathode 311; a field emission portion 302 formed on the cathode 311; and a light-permeable anode 317 arranged opposite from the cathode 311. The anode 117 is formed on a transparent substrate 318. At least one fluorescent layer 316 is formed on the anode 317 and faces the cathode 311.

The field emission portion 302 includes a plurality of supporters 314 formed on the cathode 311; and a plurality of field emitters 315 formed on the supporters 314.

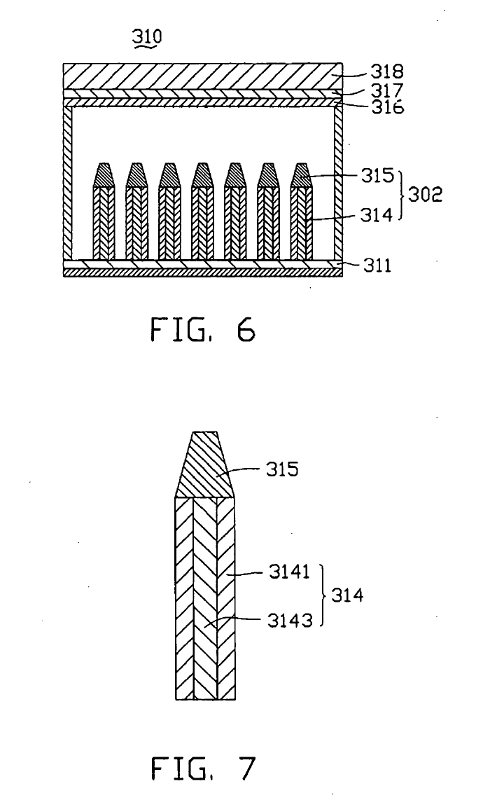

Referring to FIG. 7, a single exemplary supporter 314 and a corresponding field emitter 315 are described as follows. The supporter 314 of the second embodiment is similar to the isolating post 114 of the first embodiment, except that the supporter 314 includes a conductive core portion 3143 and an isolating enclosing portion 3141 surrounding the core portion 3143 therein. Further, the conductive core portion 3143 interconnects the cathode 311 and the corresponding field emitter 315. As such, the conductive core portion 3143 provides an electrically conductive connection between the cathode 311 and the corresponding field emitter 315.

In a process for manufacturing a supporter 314, a through hole is defined in a preformed solid isolating enclosing portion 3141. A conductive metal material, such as copper, gold, silver or their alloys, is then filled into the through hole of the isolating enclosing portion 3141, thereby obtaining the supporter 314. Alternatively, the conductive metal material could be first selectively deposited to form the core portions 3143 and then the material of the corresponding enclosing portions 3141 could be deposited therearound, either selectively to the desired surrounding shape or subsequently etched or otherwise shaped to a desired outer configuration.

It should be noted that the above-described light guiding plate 120 has been provided for the purposes of illustrating the present invention. The light guiding plate 120 is not critical to practicing the present invention. A variety of conventional light guiding plates are known to those skilled in the art and may be suitably adapted for practicing the present invention. In particular, configurations of the light incident surface 121, the light emitting surface 122, and the light reflecting surface 123 are exemplified herein for illustration purposes only and are not intended to limit the present invention.

Furthermore, as is known to those skilled in the art, the backlight device 100 may further include one or more of optical elements (not shown), such as a reflecting plate disposed facing the light reflecting surface 123 of the light guiding plate 120, a diffusing plate disposed facing the light emitting surface 122 of the light guiding plate 120, and/or a brightness-enhancing plate stacked over the diffusing plate.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A backlight device comprising:
a light source comprising:
a cathode;
a base having at least one isolating supporter disposed on the cathode;
at least one field emitter, each field emitter being formed on a respective isolating supporter of the base; and
a light-permeable anode arranged over and facing the field emitter, and
a light guiding plate having an incident surface facing the light-permeable anode, the incident surface thereof being adapted for receiving light emitted from the light source.

2. The backlight device according to claim 1, wherein each isolating supporter includes an isolating layer.

3. The backlight device according to claim.1, wherein each isolating supporter includes an isolating post.

4. The backlight device according to claim 3, wherein each isolating post and the corresponding field emitter have a total length in the range from about 100 nanometers to about 2000 nanometers.

5. The backlight device according to claim 3, wherein the isolating post is one of cylindrical, conical, annular, and parallelepiped-shaped.

6. The backlight device according to claim 3, wherein the isolating post has at least one of a width and a diameter in the range from about 10 nanometers to about 100 nanometers.

7. The backlight device according to claim 1, wherein the isolating supporter is comprised of silicon nitride.

8. The backlight device according to claim 1, wherein the field emitter is comprised of niobium.

9. The backlight device according to claim 1, wherein the field emitter has a diameter in the range from about 0.5 nanometers to about 10 nanometers.

10. The backlight device according to claim 1, wherein the base further includes an electrically conductive connecting portion configured for establishing an electrically conductive connection between the field emitter and the cathode.

11. The backlight device according to claim 10, wherein the isolating supporter includes a through hole, and the electrically conductive connecting portion is received therein.

12. The backlight device according to claim 1, wherein the light source further includes a nucleation layer sandwiched between the cathode and the base.

13. The backlight device according to claim 12, wherein the nucleation layer is comprised of silicon.

14. The backlight device according to claim 12, wherein the nucleation layer has a thickness in the range from about 2 nanometers to about 10 nanometers.

15. A backlight device, comprising:
a light source, comprising:
a cathode;
a field emission portion formed on the cathode, the field emission portion including a plurality of field emitters; and
a light-permeable anode arranged over and facing the field emitters; and
a light guiding plate having a light incident surface, the incident surface thereof being configured for receiving light from the light source.
